(19) United States
(12) Patent Application Publication
(10) Pub. No.: US 2024/0279575 A1
(43) Pub. Date: Aug. 22, 2024

(54) HIGH MOISTURE SILICA GEL SOAP BARS AND PROCESS FOR PREPARING THE SAME

(71) Applicant: Conopco, Inc., d/b/a UNILEVER, Englewood Cliffs, NJ (US)

(72) Inventors: Amalendu BANGAL, Dist-Paschim Midnapore (IN); Sudipta GHOSH DASTIDAR, Bangalore (IN); Chandra Sekhar GHOSH, Howraw (IN); Meena RAJAN, Mumbai (IN)

(73) Assignee: Conopco, Inc., d/b/a UNILEVER, Englewood Cliffs, NJ (US)

(21) Appl. No.: 18/568,413

(22) PCT Filed: Jun. 7, 2022
(86) PCT No.: PCT/EP2022/065380

§ 371 Date: Dec. 8, 2023

(30) Foreign Application Priority Data
Jun. 10, 2021 (IN) 202121025987
Jul. 23, 2021 (EP) 21187455.7

(51) Int. Cl. C11D 9/02; C11D 9/12; C11D 9/18; C11D 9/26; C11D 10/04; C11D 17/00

(52) U.S. Cl. CPC C11D 9/02; C11D 9/12; C11D 9/18; C11D 9/265; C11D 10/042; C11D 17/0065

(57) ABSTRACT

Disclosed is a soap composition comprising 45 to 75 wt % total fatty matter: 0.1 to 3 wt % electrolyte comprising sodium sulphate; silica gel; and 15 to 30 wt % moisture. The invention also provides process of making high moisture soap bars with good hardness by in situ generation of silica gel during the soap making process.

### FIELD OF THE INVENTION

The invention relates to extruded soap-based products like noodles and bars. More particularly, it relates to such compositions having significantly higher moisture as compared to conventional products

### BACKGROUND OF THE INVENTION

Surfactants have been used for personal wash applications for a long time. There are many categories of products in the personal wash market e.g. body wash, face wash, hand wash, soap bars, shampoos etc. Products which are marketed as body wash, face wash and shampoos are generally in liquid form and are made of synthetic anionic surfactants. They are generally sold in plastic bottles/containers. Soap bars and hand wash products generally contain soaps. Soap bars do not need to be sold in plastic containers and are able to retain their own shape by virtue of being structured in the form of a rigid solid. Soaps bars are usually packaged in cartons made of cardboard or plastic laminated wrappers.

Soap bars are generally prepared through one of two routes. One is called the cast bar route while the other is called the milled and plodded route (also known as extrusion route). The cast bar route has inherently been very amenable in preparing low TFM (total fatty matter) bars. Total fatty matter is a common way of defining the quality of soap. TFM is defined as the total amount of fatty matter, mostly fatty acids, that can be separated from a sample of soap after splitting with a mineral acid, usually hydrochloric acid. In the cast bar soaps, the soap mixture is mixed with polyhydric alcohols and poured in moulds and allowed to cool and then the soap bars are removed from the casts. The cast bar route enables production at relatively lower throughput rates.

Bars of soap bars are generally made from noodles, usually with 40% to 80 wt % or more of total fatty material (TFM), 10 to 35 wt % water (moisture), and additives like fillers, salts, other surfactants, and fragrance. These bars are mainly produced by mixing the noodles with the other ingredients, followed by the steps of milling, extruding and stamping.

In the milled and plodded route, the soap is prepared with high water content and then spray dried to reduce the moisture content and to cool the soap after which other ingredients are added and then the soap is extruded through a plodder and optionally cut and stamped to prepare the final soap bar. The milled and plodded soaps generally have a high TFM in the range of 60 to 80 weight percent. Most soap compositions comprise both water insoluble as well as water soluble soaps. Their structure is generally characterized by a brick and mortar type structure. Insoluble soaps (called bricks) usually consist of higher chain C16 and C18 soaps (stearate and palmitate soap). They are generally included in soap bars to provide structuring benefits i.e., they provide shape to the bars. Soap bars also consist of water soluble soaps (which act as the mortar) which are generally unsaturated C18:1 and 18:2 sodium soap (oleate soap) in combination with short chain fatty acids (generally C8 to C12 or even up to C14 soap). Water soluble soaps generally aid in cleaning.

The present invention relates to bars of soap which are made by extrusion process, especially at high-speeds, which we define herein to mean bars which can be extruded, cut and stamped at a rate of at least 200 bars per minute. The bars are predominantly fatty acid soap bars where the total fatty matter (TFM) is 40 to 80 wt %, preferably 50 to 70 wt %.

Usually soap bars contain an excess of active soap than necessary for cleansing or surfactant properties. This is because much of the sodium soaps are there to structure the bar. It is possible to replace a part of the total soap content with solvent (e.g., glycerin and water) or particulates. This method can reduce the cost of production of the bars and could also bring additional benefits to consumers, such as mildness. However, an increase in moisture content could result in softer and tackier bars and may cause problems during extrusion and stamping and could reduce the speed of production.

In addition to about 40 to 80 wt % TFM, soap bars presently prepared through the extruded route for personal wash contain about 12 to 25 wt % water. There is a need for developing sustainable technologies where one approach is to develop soaps with lower TFM content and by increasing the water or moisture content with no compromise or other properties and desirable features. The present inventors are aware of a variety of approaches to structure soap bars, like inclusion of aluminium phosphate. Such technologies are useful for preparing bars for laundering application but such materials are not so much skin friendly and so are not appropriate for personal washing. If one simply substitutes the TFM with higher amount of water, it causes problems during extrusion of the soap mass and further the extruded bars are sticky and cannot be stamped easily. The present inventors are also aware of various other approaches like inclusion of natural aluminosilicate clays like bentonite or kaolinite but they are found to not as efficient in structuring the bars at low amounts.

To counter the effect of increased water levels, it is possible to add electrolytes to the composition. The electrolyte serves to “shorten” the soap by which is meant that the soap bar increases in hardness and becomes less sticky. However, the addition of electrolytes may lead to greater degree of cracking or fissures in the extruded bars (to a level unacceptable by consumer); and could further lead to formation of an electrolyte layer on the bar surface which is visible to the naked eye, a phenomenon referred to as “efflorescence”.

One strategy that has been used to reduce the soap content in bars is to replace part of the fatty acid soap by inorganic fillers and/or higher levels of water. However, the use of high levels of inorganic fillers and/or high water levels leads to several negative properties which includes a significant shrinkage of the bar during storage by evaporation of water and to a smaller bar volume because of the higher density of inorganic fillers.

Another approach that has been used to lower the surfactant content of bars is the use of coagels formed in a melt-cast process. Here a molten surfactant solution is poured into a mold and cooled. The surfactant solution forms a highly extended three-dimensional network. Although melt-cast technology yields bars that have lower surfactant content, the process is less efficient than high-throughput extrusion. Furthermore, melt-cast bars have substantial levels of water and solvents, are subject to drying out and their rate of wear is much higher than milled toilet soaps. Consequently, such bars are less economical in use than milled soaps.

Examples of approaches based on the above concepts include the following.

GB2238316 A (Unilever, 1991) discloses a toilet or laundry bar comprising 30 to 70% by weight of soap or a mixture of soap and synthetic detergent reckoned as anhydrous; 0.1 to 20% by weight of mineral or organic acid; 5 to 30% by weight alkaline silicate; and 10 to 40% by weight of water.

US2014378363 A1 (Henkel) discloses low TFM soap bars containing talcum, starch and silicates. Talcum, starch and silicates constitute the structuring system.

WO 01/42418 to Chokappa et al discloses a detergent bar containing 0.5 to 30% amorphous alumina, one alkali metal salt of carboxylic/sulfonic acid, 5-70% detergent active and 10-55% water.

WO 2006/094586 to Gangopadhayay et al discloses a low TFM detergent bar including soap (15% to 30% TFM); 25% to 70% inorganic particulates including talc and calcium carbonate; 0.5% to 10% of alumino-silicate; and 3% to 20% water.

U.S. Pat. No. 6,440,908 to Racherla discloses high moisture containing bar compositions that includes a borate compound which enables the retention of high amounts of moisture without compromising bar properties.

WO 96/35772 to Wise et al discloses laundry bar compositions including from about 20% to about 70% surfactant; from about 12% to about 24% water; from about 6.25% to about 20% calculated excess alkali metal carbonate; from about 2% to about 20% water-soluble inorganic strong-electrolyte salt; and various optional ingredients including whole-cut starch.

WO98/18896 to Rahamann et al discloses laundry bar composition including structured soap composition; from about 5% to about 50% starch; and about 25% to about 45% moisture.

US 2007/0021314 and US 2007/0155639 to Salvador et al disclose cleansing bar compositions that include (a) at least about 15%, water; (b) from about 40% to about 84% soap; and (c) from about 1% to about 15%, inorganic salt. The bar compositions further comprise a component selected from the group consisting of carbohydrate structurant, humectants, free fatty acid, synthetic surfactants, and mixtures thereof.

U.S. Pat. No. 6,838,420B2 to Sachdev et al discloses a translucent or transparent composition comprising a. about 3 to about 40 wt. % soap, b. about 4 to about 40 wt. % of at least one synthetic surfactant, c. about 14 to about 45 wt. % water, d. from 0 to about 3 wt. % lower monohydric alcohol, e. about 5 to about 60 wt. % of a humectant, f. from 0 to about 5 wt. % of a structurant, g. from 0 to about 10 wt. % of a gellant with the proviso that the structurant and gellant are not 0 at the same time.

U.S. Pat. No. 4,808,322 to James Mclaughlin discloses a non-foaming skin cleansing-conditioning bar consisting essentially of 14% to 18% of specific anionic surfactant materials; about 40% to 72% of specific water-insoluble emollients; 0% to 25% of a starch-derived filler; and 2% to 12% of water.

WO08055765 to Jagdish Gupta discloses soap prepared from fatty matter having 8 to 22, carbon atoms, 30 to 60%, total fatty matter (TFM). Of the total fatty matter it is preferred that 70 to 90% of the total fatty matter by weight is unsaturated. The soap bar has less than 30%, saturated fatty matter by weight of total fatty matter. Previous work described in Patent Application GB 806340.6 identified lower TFM extrudable soap bar compositions that included starch, specific polyols and optionally water insoluble particles that did not require high levels of water and inorganic fillers. However, this technology was limited to compositions having a total level of fatty acid soap no lower than 45%. It was found that when the fatty acid soap level fell below about 45%, especially below 40%, the processing and in-use properties became progressively more sensitive to small changes in composition. This sensitivity increased as the total fatty acid soap level was reduced towards 20% soap made large scale production problematic.

WO2010089269 A1 (Unilever) discloses a low TFM extruded personal washing bar having a continuous phase comprising: a. 20% to less than 45% fatty acid soap in which the fatty acid soap comprises at least 30% saturated fatty acid soaps based on the total weight of the soap and wherein the fatty acid soap has a ratio ROL, defined as the total weight of oleics fatty acids soaps divided by the total weight of the laurics fatty acid soaps which satisfies Eq (1); ROL=(−0.00063(TS2)+0.297(TS)−1.95)±15% (1) where TS is the weight % fatty acid soap in the composition; b. a structuring system comprising: i) from 10% to 40% by weight of continuous phase of a polysaccharide structurant selected from the group consisting of starch, cellulose and a mixture thereof ii) from 8.0% to 30% by weight of continuous phase of a polyol selected from the group consisting of glycerol, sorbitol and their mixtures, and iii) 0 to 15% by weight of continuous phase of water insoluble particulate material, wherein the weight of polysaccharide structurant divided by the weight of polyol, designated Rsp, is in the range from 0.3 to 5.0 and wherein continuous phase is an extrudable mass having a penetrometer hardness of 3 to 8 Kg and a yield stress of 350 to 2000 kPa measured at a temperature of 40° C.

WO2019115435 A1 (Unilever) discloses a structuring system having a combination of hydrated sodium carbonate and a hydrated aluminium material, silica material can be used to provide detergent bars capable of retaining high levels of moisture.

WO2020/169306 (Unilever) discloses an extruded soap bar composition and more particularly relates to a soap bar composition which comprises low amount of soap where high amount of water can be incorporated. This is achieved by including selective amount of a mixture of sodium or calcium silicate and an acrylic/acrylate polymer, wherein the soap bar comprises 0.01 to 0.7 wt % of the polymer. WO2020/169306 discloses that merely including sodium silicate in a low TFM soap bar composition does not give the desired hardness that is found in high TFM soap bars. WO2020/169306 discloses that small amounts of specific polymer of the acrylic/acrylate class in a low TFM soap bar with high water content and also comprising a silicate compound was able to structure soap bars to the desired hardness. WO2020/169306 discloses that the inclusion of the polymer and lower amount of silicate had to be included for achieving synergistic benefits with the combination of the two structuring agents. Therefore, the invention of WO2020/169306 relies on the synergy between silicate and the polymer to achieve the desired hardness.

Therefore, there is a need for a soap bar composition which does not rely on polymers as means for structuring a high moisture content soap bar and still provides good hardness and absence of efflorescence.

### SUMMARY OF THE INVENTION

In accordance with a first aspect is disclosed a soap composition comprising:
i. 45 to 75 wt % total fatty matter;
ii. 0.1 to 3 wt % electrolyte comprising sodium sulphate;
iii. silica gel; and
iv. 15 to 30 wt % moisture.

In accordance with a second aspect is disclosed a process for preparing a soap composition of the first aspect, comprising the steps of:
i) saponifying a fatty saponifiable matter with an alkali to produce a saponified mass, while monitoring the extent of saponification;
wherein 0.1 to 3 wt % of an electrolyte comprising sodium sulphate is added during the saponification process;
ii) adding a bicarbonate salt in the range of 0.5 to 5 wt % of the total soap composition to the saponified mass obtained from step (i) and mixing;
iii) adding water to the mix of step (ii);
iv) adding of alkaline silicate salt heated to 40 to 80° C. in the range of 0.25 to 5 wt % of the total soap composition; and optionally; and
v) extruding said saponified mass into shaped products including noodles and bars.

As used herein the term “comprising” encompasses the terms “consisting essentially of” and “consisting of”. Where the term “comprising” is used, the listed steps or options need not be exhaustive. Unless otherwise specified, numerical ranges expressed in the format “from x to y” are understood to include x and y. In specifying any range of values or amounts, any particular upper value or amount can be associated with any particular lower value or amount. Except in the examples and comparative experiments, or where otherwise explicitly indicated, all numbers are to be understood as modified by the word “about”. All percentages and ratios contained herein are calculated by weight unless otherwise indicated. As used herein, the indefinite article “a” or “an” and its corresponding definite article “the” means at least one, or one or more, unless specified otherwise. The various features of the present invention referred to in individual sections above apply, as appropriate, to other sections mutatis mutandis. Consequently, features specified in one section may be combined with features specified in other sections as appropriate. Any section headings are added only for convenience and are not intended to limit the disclosure in any way. The invention is not limited to the embodiments illustrated in the drawings. Accordingly, it should be understood that where features mentioned in the claims are followed by reference numerals, such numerals are included solely for the purpose of enhancing the intelligibility of the claims and are in no way limiting to the scope of the claims.

Throughout the specification unless otherwise specified, wt % means weight % of the total weight of soap composition of the present invention.

Various components of the composition are described in greater detail below.

### DETAILED DESCRIPTION OF THE INVENTION

Soap based products like noodles and bars require need to have physical strength so that they retain their structural integrity during handling, transport and use. The hardness of the bars, at the time of manufacture and subsequently, is an especially important property.

Inclusion of certain ingredients like minerals to make the bar harder usually results in higher density bars, making the bars considerably smaller, thus less attractive to the consumer and gritty to feel.

Soap noodles are typically made from oil or fat or blends by methods commonly known in the art. One of the methods is direct saponification of oil/fat in which the oil/fat is reacted with an alkali (typically sodium hydroxide) to form glycerin and the soap base (which contains fatty acid alkali salt, e.g., fatty acid sodium salt, which is also carboxylic acid sodium salt). The soap base is the fatty-acid-alkali-salt-containing material. Thus, the material after removal of glycerin (if glycerin is to be removed) and to be further processed is an example of soap base. Another method involves neutralization of fatty acid with the alkali (e.g., NaOH) to form the soap base. In the soap-making process, the soap base can be dried and plodded into noodles or chips. As used herein, the term “soap noodles” refers to the pellets or pieces of soap (whether they be in pellet, chip, bits, or other shapes). Soap noodles are typically the result of the drying and extruding of raw soap into unit form such that the soap units or pieces can be further processed into the finished soap bars by mixing with additives, as known to those skilled in the art of soap making.

In the process of saponification, various fats (e.g., tallow, palm and/or coconut or PKO oil blends) are saponified in the presence of alkali (usually NaOH) to yield alkaline salts of fatty acids (derived from the fatty acid chains forming the glyceride) and glycerol. Glycerol is then typically extracted with brine to yield dilute fatty acid soap solution containing soap (soaps formed after saponification and before extrusion to final bar are referred to often as soap “noodles”) and aqueous phase (e.g., 70% soap and 30% aqueous phase).

In this invention, the inventors have determined that a soap composition such as in the form of noodles, pellets, bars, tablets with the ability to retain and structure from 15 to 30 wt % moisture can be prepared by a simple, yet effective manner by using an in-situ generation of silica gel. The inventors have also determined that such products, example bars, can be prepared by very minor changes to conventional process and without the need for additional structuring agents, or machines or equipment. Inventors also surprisingly found that when the wt % of surfactants was increased to improve the lather performance of the soap bar the conventional bars become softer, but the soap bar of the present invention showed good hardness properties.

When herein used “in situ” generated silica gel is intended to cover silica gel prepared separately and added at the appropriate stage during the process.

It is preferable that the present invention does not require a structuring system comprising a mixture of sodium or calcium silicate and an acrylic/acrylate polymer.

It is further preferable that the present invention is substantially free of the structuring system comprising a mixture of sodium or calcium silicate and an acrylic/acrylate polymer and more preferably ‘essentially free’ of the structuring system comprising a mixture of sodium or calcium silicate and an acrylic/acrylate polymer, and most preferably ‘completely free’ of the structuring system comprising a mixture of sodium or calcium silicate and an acrylic/acrylate polymer.

In a highly preferred aspect of the present invention, the composition is substantially free of acrylic/acrylate polymer and more preferably ‘essentially free’ of an acrylic/acrylate polymer, and most preferably ‘completely free’ of an acrylic/acrylate polymer.

The term ‘substantially free’ means that less than 1 wt %. Likewise, ‘essentially free’ means that less than 0.01 wt % and ‘completely free’ means less than 2.0×10-6 wt % by weight of the said composition.

It is well known in the art that the presence of alkaline silicate salt as a reactant in the soap bar results in efflorescence (Luis Spitz, Alex Sevilla,9—Soap, Soap/Synthetic, and Synthetic Laundry Bars, Editor(s): Luis Spitz, Soap Manufacturing Technology (Second Edition), AOCS Press, 2016, Pages 203-219, ISBN 9781630670658). Therefore, it was a surprising finding of the present invention that due to the presence of silica gel in the composition efflorescence was not seen.

The inventors of the present invention observed that in situ generation of silica gel shows better hardness and is able to better incorporate water than the conventional soap. It was further observed that presence of sodium sulphate as an electrolyte gives better hardness to the bar.

The present invention relates to a soap composition comprising:
i. 45 to 75 wt % total fatty matter;
ii. 0.1 to 3 wt % electrolyte comprising sodium sulphate;
iii. silica gel; and
iv. 15 to 30 wt % moisture.

### Soap

The present invention relates to a soap composition. By a soap composition is meant a cleansing composition comprising soap which is in the form of a shaped solid. It is preferred that the composition is shaped in the form of noodles or bars. More preferably the composition of the invention is in the form of a bar. The bars in turn, could have a variety of shapes including rectangular, square, or oval cross section. The composition of the present invention is in the form of a shaped solid for example a bar. The cleaning soap composition is generally a wash off products have sufficient amounts of surfactants included therein that it is used for cleansing the desired topical surface e.g. the whole body, the hair and scalp or the face. It is applied on the topical surface and left thereon only for a few seconds or minutes and washed off thereafter with copious amounts of water.

The soap bar of the invention is especially useful for personal cleansing. The soap bar of the present invention preferably comprises 40 to 80% total amount of TFM from soap, preferably 45 to 75% and more preferably 55 to 65 wt % TFM from soap. The term soap means salt of fatty acid. Preferably, the soap is soap of C8 to C24 fatty acids.

The cation may be an alkali metal, alkaline earth metal or ammonium ion, preferably alkali metals. Preferably, the cation is selected from sodium or potassium, more preferably sodium. The soap may be saturated or unsaturated. Saturated soaps are preferred over unsaturated soaps for stability. The oil or fatty acids may be of vegetable or animal origin.

The soap may be obtained by saponification of oils, fats or fatty acids. The fats or oils generally used to make soap bars may be selected from tallow, tallow stearins, palm oil, palm stearins, soya bean oil, fish oil, castor oil, rice bran oil, sunflower oil, coconut oil, babassu oil, and palm kernel oil. The fatty acids may be from coconut, rice bran, groundnut, tallow, palm, palm kernel, cotton seed or soybean.

The fatty acid soaps may also be synthetically prepared (e.g. by the oxidation of petroleum or by the hydrogenation of carbon monoxide by the Fischer-Tropsch process). Resin acids, such as those present in tall oil, may also be used. Naphthenic acids may also be used.

The soap bar may additionally comprise synthetic surfactants selected from one or more from the class of anionic, non-ionic, cationic or zwitterionic surfactants, preferably from anionic surfactants. These synthetic surfactants, as per the present invention, are included in less then 8%, preferably less then 4%, more preferably less then 1.5% and sometimes absent from the composition.

The soap bars of the present invention preferably includes low molecular weight soaps (C8 to C14 soaps) which are generally water soluble, which are in the range of 2 to 20% by weight of the composition. It is preferred that the soap bar includes 15 to 55 wt % of the soap of C16 to C24 fatty acid, which are generally water insoluble soaps. Unsaturated fatty acid soaps preferably at 15 to 35% may also be included in the total soap content of the composition. Unsaturated soaps are preferably oleic acid soaps.

The chain length of soaps depends on the fat or oil feedstock which is usually a blend. For purposes of this specification, “oil” and “fat” are used interchangeably, except where context demands otherwise. Longer chain fatty acid soaps (e.g., C₁₆ palmitic or C₁₈ stearic) are typically obtained from tallow and palm oils, and shorter chain soaps (e.g., C₁₂ lauric) may typically be obtained from, for example, coconut oil or palm kernel oil. The fatty acid soaps produced may also be saturated or unsaturated (e.g., oleic acid).

Typically, longer chain fatty acid soaps (e.g., C₁₄ to C₂₂ soaps) especially longer, saturated soaps are insoluble and do not generate enough foam upon use but they can make the foam creamier and more stable. Conversely shorter chain soaps (e.g., C₈ to C₁₂) and unsaturated soaps (e.g., oleic or linoleic acid soap) lather quickly. However, the longer chain soaps (typically saturated, although they may also contain some level of unsaturated such as oleic) are desirable to maintain structure and not dissolve as readily. Unsaturated soaps (e.g., oleic) are soluble and lather quickly, like short-chained soaps, but form a denser, creamier foam, like the longer chained soaps.

Iodine value is an indicator of unsaturation and there are well known methods of measurement of IV. One method is gas chromatography. In this method, methyl esters of the fatty acids are formed and analysed by the chromatographic technique. In addition, there are wet chemical methods of analyses. It is possible to measure iodine value of a fat blend before saponification. Additionally, it is possible to determine the iodine value of a soap (saponified oil or fatty acids) present in a finished good like a bar of soap or noodles of soap.

It is preferred that said fatty matter is derived by saponification of a saponifiable fat blend, where iodine value of said fat blend is from 30 to 45 grams Iodine per 100 grams of said blend.

It is preferred that the free alkali content of said soap is 0.05 to 0.1.

It is preferred that the sodium sulphate is in the range of 0.1 to 1.5 wt % of total weight of the composition.

It is preferred that the electrolyte comprises sodium sulphate and sodium chloride.

It is preferred that the sodium chloride is in the range of 0.5 to 1.5 wt % of total weight of the composition.

It is preferred that the iodine value is 30 to 45 g/Iodine per 100 g of said saponified fatty matter.

It is preferred that the composition comprises from 0.2 wt. % to 10 wt. % silica gel.

It is preferred that the composition has a pH when measured in a 4% solution with distilled water at 25° C. in the range from 9 to 13. More preferably pH of 4% solution should be between 10-11.

### Silica Gel

According to a first aspect of the present invention disclosed is a laundry soap bar composition having silica gel.

Silica gel may be pre-formed silica gel, or the generation of silica gel may be in-situ during the manufacturing process. It is however preferable that the silica gel is formed in-situ in the process of the present invention. It is understood that silica gel is a porous form of silicon dioxide. Silica gels are amorphous solids. The partial dipole in the Si—O bond allows silica gel to hydrogen bond with water molecules while the porous nature and large surface area of silica gel enables the material to readily adsorb water. In accordance with embodiments of the present invention, metal silicates can form silica gel in-situ during the manufacture of laundry soap bar composition.

Preferably the silica gel is formed in-situ by acidulation of an alkaline metal silicate salt. Any metal silicate that can convert to silica gel is suitable for the present invention. For example, alkali metal silicates such as sodium silicate, potassium silicate, lithium silicate, Calcium silicate or any combination thereof are suitable for the present invention. The alkaline metal silicate can be added by itself (in a solid form) or in a wet form, such as a slurry or solution. The alkaline metal silicate component is preferably sodium silicate or alternatively, sodium silicate in combination with another metal silicate. Sodium silicate is a basic inorganic compound which is readily soluble in water, sodium silicate is often sold as an aqueous solution.

The sodium silicates are frequently referred to or characterized by their alkaline oxide to silica ratio, such as their ratio of Na₂O to SiO₂. Orthosilicate, having the formula Na₄SiO₄, is the most alkaline having a Na₂O to SiO₂ ratio of 2:1. Metasilicate, Na₂SiO₃ has a Na₂O to SiO₂ ratio of 1:1. The so-called “water glass” silicates, which are soluble in water, have a Na₂O to SiO₂ ratio in the range of about 1:1.5 to 1:3.8. Preferably the Na₂O to SiO₂ ratio used in the present invention is from 1:1 to 1:3.0. In preparing the silica gel in accordance with this invention commercially available alkali metal silicates may be employed in which the ratio of sodium oxide to silicon dioxide may range from 1:0.48 to 1:3.75, preferably the range from 1:1 to 1:3.75 and more preferably 1:1 to 1:3.5. Examples of silicates which may be used for purposes of this invention are Alkaline sodium silicate (Na₂O to SiO₂, ratio of 1:3.0), sodium ortho silicate (Na₂O to SiO₂, ratio of 2:1) and potassium silicate (K₂O to SiO₂, ratio of 1:2.50). Preferably the alkali metal silicate is alkaline.

Preferably the generation of silica gel is in-situ by acidulation of alkaline silicate with a reactant selected from the class consisting of carbon dioxide, alkali metal bicarbonates or mixtures thereof. The carbon dioxide gas employed may be full strength or may be diluted with air or other inert gases, example such as the dilute carbon dioxide gas produced by the combustion of hydrocarbons such as propane or butane. Preferably the bicarbonate salt is an alkali metal salt, more preferably sodium bicarbonate. Preferably the alkaline silicate is water-soluble or water dispersible.

It is within the scope of the present invention to form in-situ silica gel by reacting the water soluble or water-dispersible silicates with organic acids. Preferably the organic acids are anionic, detergent-forming acids. Non-limiting examples of the acids are saturated and unsaturated fatty acids, having a carbon chain containing from about 8 to 22 carbon atoms, exemplified by lauric, stearyl, oleic and linoleic acid. Non-soap detergent forming acids such as alkyl aryl sulfonic acids, wherein the alkyl group (both linear and branched) has a carbon chain length of at least 4 carbon atoms, preferably from 10 to 12 carbon atoms in the chain which are capable of forming water-soluble non-soap detergents upon neutralization with alkali such as sodium or potassium hydroxide.

The degree of silicate polymerization to silica gel is preferably 50% or more (i.e., a ratio of 1:1), more preferably 60% or more, further preferably 70% or more, still further preferably 80% or more, still further preferably 90% or more, furthermore preferably 95% or more, and most preferably 99%, or more. Preferably the alkali metal silicate is fully polymerized to silica gel.

Preferably the composition according to the present invention comprises from 0.2 wt. % to 10 wt. % silica gel, preferably from 0.5 to 5 wt %, and more preferably from 1 to 3 wt %. Preferably the soap bar composition comprises at least 0.2 wt. %, preferably at least 0.3 wt. %, still preferably at least 0.5 wt. % and most preferably at least 0.7 wt. %, but typically not more than 10 wt. %, still preferably not more than 7 wt. %, still further preferably not more than 5 wt. %, and most preferably not more than 3 wt. % silica gel in the soap bar composition.

Silicate polymerization reaction can be considered as acid base reaction. Reaction can be expressed as below-

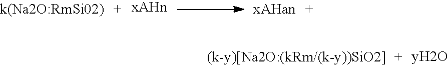

Where,
Rm is ratio of SiO₂ and Na₂O,
k is moles of Sodium silicate
x is moles of acid (Salt of acid)
n is no of protons in acid and
y=nx/2.

Generally, over the reaction acid neutralizes alkali (Na₂O) associated with alkaline silicate and thus increase Rm. i.e. a partial polymerization of the silicate towards silica and the formation of a ‘salt’. Preferably degree of polymerization of silicate to silica gel is 50% to 99%, preferably the degree of polymerization is more than 90%, more preferably more than 95% and most preferably more than 99% of the complete polymerization.

### Alkaline Silicate Salt

The present invention uses alkaline silicate salt as one of the reactants in the method of manufacture of the soap bar of the present invention. It is preferable that the alkaline silicate salt is used in the range of 0.25 to 5 wt %, more preferably 0.5% to 3% and most preferably 0.7 to 2.25 wt % on dry weight basis of the weight of composition of the present invention. It is preferred that alkaline silicate salt is an alkaline metal silicate salt and most preferably sodium, calcium, lithium or potassium silicate salt. It is highly preferred that the alkaline silicate salt is sodium silicate or potassium silicate and more preferably sodium silicate.

When sodium silicate is used it is in the range of 0.25 to 5 wt %, more preferably 0.5% to 3% and most preferably 0.7 to 2.25 wt % on dry weight basis of the weight of composition of the present invention.

When potassium silicate is used it is in the range of 0.25 to 5 wt %, more preferably 0.5% to 3% and most preferably 0.7 to 2.25 wt % on dry weight basis of the weight of composition of the present invention.

It is preferred that sodium silicate includes compounds having the formula (Na₂O)ₓ·SiO₂.

It is preferred that in the alkaline silicate salt the ratio of alkaline oxide to silicon oxide is in the range of 1:1.8 to 1:2.8, more preferably 1:1.8 to 1:2.6 and most preferably from 1:1.7 to 1:2.5 and even more preferably from 1:1.5 to 1:2.3. It is preferred that sodium silicate when used, the ratio of Na₂O:SiO₂ in the range of 1:1.8 to 1:2.8, more preferably 1:1.8 to 1:2.6 and most preferably from 1:1.7 to 1:2.5 and even more preferably from 1:1.5 to 1:2.3.

### Organic and Inorganic Adjuvant Materials

The total level of the adjuvant materials used in the bar composition should be in an amount not higher than 50%, preferably 1 to 50%, more preferably 3 to 45% by wt. of the soap bar composition.

Suitable starchy materials which may be used include natural starch (from corn, wheat, rice, potato, tapioca and the like), pre-gelatinzed starch, various physically and chemically modified starch and mixtures thereof. By the term natural starch is meant starch which has not been subjected to chemical or physical modification—also known as raw or native starch.

The raw starch can be used directly or modified during the process of making the bar composition such that the starch becomes gelatinized, either partially or fully gelatinized.

The adjuvant system may optionally include insoluble particles comprising one or a combination of materials. By insoluble particles is meant materials that are present in solid particulate form and suitable for personal washing. Preferably, there are mineral (e.g., inorganic) or organic particles.

The insoluble particles should not be perceived as scratchy or granular and thus should have a particle size less than 300 microns, more preferably less than 100 microns and most preferably less than 50 microns.

Preferred inorganic particulate material includes talc and calcium carbonate. Talc is a magnesium silicate mineral material, with a sheet silicate structure and a composition of Mg₃Si₄(OH)₂₂ and may be available in the hydrated form. It has a plate-like morphology, and is essentially oleophilic/hydrophobic, i.e., it is wetted by oil rather than water.

Calcium carbonate or chalk exists in three crystal forms: calcite, aragonite and vaterite. The natural morphology of calcite is rhombohedral or cuboidal, acicular or dendritic for aragonite and spheroidal for vaterite.

Examples of other optional insoluble inorganic particulate materials include aluminates, phosphates, insoluble sulfates, borates and clays (e.g., kaolin, china clay) and their combinations.

Organic particulate materials include: insoluble polysaccharides such as highly crosslinked or insolubilized starch (e.g., by reaction with a hydrophobe such as octyl succinate) and cellulose; synthetic polymers such as various polymer lattices and suspension polymers; insoluble soaps and mixtures thereof.

Bar compositions preferably comprise 0.1 to 25% by wt. of bar composition, preferably 5 to 15 by wt. of these mineral or organic particles.

An opacifier may be optionally present in the personal care composition. When opacifiers are present, the cleansing bar is generally opaque. Examples of opacifiers include titanium dioxide, zinc oxide and the like. A particularly preferred opacifier that can be employed when an opaque soap composition is desired is ethylene glycol mono- or di-stearate, for example in the form of a 20% solution in sodium lauryl ether sulphate. An alternative opacifying agent is zinc stearate.

The product can take the form of a water-clear, i.e. transparent soap, in which case it will not contain an opacifier.

The pH of preferred soaps bars of the invention is from 8 to 11, more preferably 9 to 11.

A preferred bar may additionally include up to 30 wt % benefit agents. Preferred benefit agents include moisturizers, emollients, sunscreens, skin lightening agents and anti-ageing compounds. The agents may be added at an appropriate step during the process of making the bars. Some benefit agents may be introduced as macro domains.

Other optional ingredients like anti-oxidants, perfumes, polymers, chelating agents, colourants, deodorants, dyes, emollients, moisturizers, enzymes, foam boosters, germicides, additional anti-microbials, lathering agents, pearlescers, skin conditioners, stabilisers, superfatting agents, sunscreens may be added in suitable amounts in the process of the invention. Preferably, the ingredients are added after the saponification step. Sodium metabisulphite, ethylene diamine tetra acetic acid (EDTA), borax or ethylene hydroxy diphosphonic acid (EHDP) are preferably added to the formulation.

The composition of the invention could be used to deliver antimicrobial benefits. Antimicrobial agents that are preferably included to deliver this benefits include oligodynamic metals or compounds thereof. Preferred metals are silver, copper, zinc, gold or aluminium. Silver is particularly preferred. In the ionic form it may exist as a salt or any compound in any applicable oxidation state. Preferred silver compounds are silver oxide, silver nitrate, silver acetate, silver sulfate, silver benzoate, silver salicylate, silver carbonate, silver citrate and silver phosphate, with silver oxide, silver sulfate and silver citrate being of particular interest in one or more embodiments. In at least one preferred embodiment the silver compound is silver oxide. Oligodynamic metal or a compound thereof is preferably included in 0.0001 to 2%, preferably 0.001 to 1% by weight of the composition. Alternately an essential oil antimicrobial active may be included in the composition of the invention. Preferred essential oil actives which may be included are terpineol, thymol, carvacol, (E)-2(prop-1-enyl) phenol, 2-propylphenol, 4-pentylphenol, 4-sec-butylphenol, 2-benzyl phenol, eugenol or combinations thereof. Further more preferred essential oil actives are terpineol, thymol, carvacrol or thymol, most preferred being terpineol or thymol and ideally a combination of the two. Essential oil actives are preferably included in 0.001 to 1%, preferably 0.01 to 0.5% by weight of the composition.

The soap composition may be made into a bar by a process that first involves saponification of the fat charge with alkali followed by extruding the mixture in a conventional plodder. The plodded mass may then be optionally cut to a desired size and stamped with a desirable indicia. An especially important benefit of the present invention is that, notwithstanding the high amount of water content of the soap bar, compositions thus prepared by extrusion are found to be easy to stamp with a desirable indicia.

The present invention also relates to a process to prepare the soap bar of the invention comprising the step of including substantially all of the structuring system to the soap when it is being produced during the saponification step. Preferably, at least, the polymer is included during the saponification stage.

The invention will now be illustrated by means of the following non-limiting examples.

An expression called total fatty matter is used very widely in the field of soaps and detergents. The term abbreviated to “TFM”, is used to denote the wt % of fatty acid and triglyceride residues present in the soap composition without taking into account the accompanying cations. For a soap having 18 carbon atoms, an accompanying sodium cation will generally amount to about 8 wt %. Other cations may be employed as desired, for example zinc, potassium, magnesium, alkyl ammonium and aluminium.

It is preferred that the composition of the invention comprises 40 to 80 wt % TFM, more preferably 45 to 75 wt % TFM and most preferably 45 to 65 wt %.

The term soap means salts of fatty acids in which the accompanying cation may be an alkali metal, alkaline earth metal or ammonium ion, preferably an alkali metal. Preferably, the cation is sodium or potassium. The soap may be saturated or unsaturated and it depends on the nature of the corresponding fatty acid and/or oil used for saponification.

It is preferred that the fat blend comprises 10 to 20 parts by weight lauric fatty acid, 35 to 50 parts by weight saturated non-lauric fatty acids and 20 to 45 parts by weight unsaturated non-lauric fatty acids, where the sum total of all fatty acids is 100 parts by weight.

Lauric fatty acid means acids derived, e.g. from coconut or palm kernel oil and comprising C12, i.e. lauric acid but may contain minor amounts, of up to 5 wt %, of shorter or longer-chain fatty acids, e.g., C10 to C14. Preferably the lauric fatty acid is derived from coconut or palm kernel oil.

Saturated non-lauric fatty acids means those fatty acids that are of higher carbon chain length than C14 and saturated. It is preferred that saturated non-lauric fatty acids comprising at least one of palmitic, myristic or stearic acid. Such fatty acids may comprise up to 2 to 3 wt % of other longer or shorter chain fatty acids, e.g., C20.

Unsaturated non-lauric fatty acids means those fatty acids that are unsaturated and of carbon chain length higher than C₁₂. It is preferred that unsaturated non-lauric fatty acids comprise one or more of oleic, linoleic, palmitoleic or linolenic acid. Such fatty acids may comprise up to 2 to 3 wt % of other longer or shorter chain fatty acids, e.g., C₂₀ or C₈. It is preferred that unsaturated non-lauric fatty acids are procured from at least one of tallow, lard, soya bean, sunflower, rice bran, linseed, olive, rapeseed, ground nut or fish oil. A variety of other alternative sources such as bioengineered oils may be employed.

Commercially available blends which may be used, with appropriate modifications or additional oils/fats, include 80/20, 85/15 blends where the lager number represents parts by weight of non-lauric fatty acids the smaller number represents the parts by weight of the lauric fatty acid.

### Form and Format

The soap composition of the invention could be in any physical form. It preferably is in the form of noodles, sheets, flakes, chips or powder, more preferably noodles.

The term “noodles” is used to refer to generally cylindrical particles prepared by extrusion and cutting or breaking noodles generally containing soap as a major ingredient.

Noodles based on soap are commonly produced by mixing dried soap chips with colourants and other minor ingredients, homogenising by working in either a mill or a refiner, and then extruding through a perforated plate with fine holes. They are generally extruded continuously and then allowed to weather sufficiently to break up into pieces from 3 to 15 mm in length. A series of rotating knives can be fitted to the face of the plate to cut the extruded noodles automatically into suitable lengths, but these tend to cause a certain amount of bunching to take place. The degree of bunching depends on the geometry of the cutting knives and holes and is also greatly affected by the plasticity and stickiness of the noodles themselves. Even where a rotating knife is not used, the quality of the noodles is dependent on the physical properties of the extruded soap. Ideally, the soap should be sufficiently plastic to extrude satisfactorily through the holes in the perforated plate but not so soft and sticky that they bunch together after extrusion. They should also be sufficiently hard and brittle to break up into the desired length range.

While noodles of soap can be used for washing and cleaning purposes, practically such noodles are used as input or raw material for making bars or tablets of soap which are sold in shops and supermarkets and are used by consumers as a personal wash composition.

Therefore, in accordance with another aspect of the invention, disclosed is a bar of soap comprising a soap composition of the first aspect of the invention. The bar may be of any shape and size, but preferably is rectangular with rounded edges and of a size that allows it to be held comfortably in one hand.

### Other Ingredients

In addition to the saponified fatty matter and the hydrogel, the soap composition of the invention, example noodles, and in particular the bars of soap, preferably comprises one or more of the following other ingredients. Choice of the ingredients and the amounts thereof are largely dependant on the formulation scientists and the purpose for which such noodles or bars are made.

### Non-Soap Surfactant

The composition of the invention preferably includes a non-soap surfactant, which acts as a co-surfactant and which is selected from anionic, non-ionic, zwitterionic, amphoteric or cationic surfactant. Preferably the composition comprises 0.1 to 15 wt % non-soap surfactant. More preferably the composition comprises 2 to 10 wt % non-soap surfactant and most preferably 3 to 6 wt %.

Suitable anionic surfactants include water soluble salts of organic sulphuric reaction products having in the molecular structure an alkyl radical containing from 8 to 22 carbon atoms, and a radical chosen from sulphonic acid or sulphuric acid ester radicals, and mixtures thereof.

Examples of suitable anionic surfactants are sodium and potassium alcohol sulphates, especially those obtained by sulphating the higher alcohols produced by reducing the glycerides of tallow or coconut oil; sodium and potassium alkyl benzene sulphonates such as those in which the alkyl group contains from 9 to 15 carbon atoms; sodium alkyl glyceryl ether sulphates, especially those ethers of the higher alcohols derived from tallow and coconut oil; sodium coconut oil fatty acid monoglyceride sulphates; sodium and potassium salts of sulphuric acid esters of the reaction product of one mole of a higher fatty alcohol and from 1 to 6 moles of ethylene oxide; sodium and potassium salts of alkyl phenol ethylene oxide ether sulphate with from 1 to 8 units of ethylene oxide molecule and in which the alkyl radicals contain from 4 to 14 carbon atoms; the reaction product of fatty acids esterified with isethionic acid and neutralized with sodium hydroxide where, for example, the fatty acids are derived from coconut oil and mixtures thereof.

The preferred water-soluble synthetic anionic surfactants are the alkali metal (such as sodium and potassium) and alkaline earth metal (such as calcium and magnesium) salts of higher alkyl benzene sulphonates and mixtures with olefin sulphonates and higher alkyl sulphates, and the higher fatty acid monoglyceride sulphates.

Suitable nonionic surfactants can be broadly described as compounds produced by the condensation of alkylene oxide groups, which are hydrophilic in nature, with an organic hydrophobic compound which may be aliphatic or alkyl aromatic in nature. The length of the hydrophilic or polyoxyalkylene radical which is condensed with any particular hydrophobic group can be readily adjusted to yield a water-soluble compound having the desired degree of balance between hydrophilic and hydrophobic elements.

Particular examples include the condensation product of aliphatic alcohols having from 8 to 22 carbon atoms in either straight or branched chain configuration with ethylene oxide, such as a coconut oil ethylene oxide condensate having from 2 to 15 moles of ethylene oxide per mole of coconut alcohol; condensates of alkylphenols whose alkyl group contains from 6 to 12 carbon atoms with 5 to 25 moles of ethylene oxide per mole of alkylphenol; condensates of the reaction product of ethylenediamine and propylene oxide with ethylene oxide, the condensate containing from 40 to 80 percent of polyoxyethylene radicals by weight and having a molecular weight of from 5,000 to 11,000; tertiary amine oxides of structure R3NO, where one group R is an alkyl group of 8 to 18 carbon atoms and the others are each methyl, ethyl or hydroxyethyl groups, for instance dimethyldodecylamine oxide; tertiary phosphine oxides of structure R3PO, where one group R is an alkyl group of from 10 to 18 carbon atoms, and the others are each alkyl or hydroxyalkyl groups of 1 to 3 carbon atoms, for instance dimethyldodecylphosphine oxide; and dialkyl sulphoxides of structure R2SO where the group R is an alkyl group of from 10 to 18 carbon atoms and the other is methyl or ethyl, for instance methyltetradecyl sulphoxide; fatty acid alkylolamides; alkylene oxide condensates of fatty acid alkylolamides and alkyl mercaptans.

Suitable cationic surfactants that can be incorporated are alkyl substituted quarternary ammonium halide salts e.g. bis (hydrogenated tallow) dimethylammonium chlorides, cetyltrimethyl ammonium bromide, benzalkonium chlorides and dodecylmethylpolyoxyethylene ammonium chloride and amine and imidazoline salts for e.g. primary, secondary and tertiary amine hydrochlorides and imidazoline hydrochlorides.

Suitable amphoteric surfactants are derivatives of aliphatic secondary and tertiary amines containing an alkyl group of 8 to 18 carbon atoms and an aliphatic radical substituted by an anionic water-solubilising group, for instance sodium 3-dodecylamino-propionate, sodium 3-dodecylaminopropane sulphonate and sodium N-2-hydroxydodecyl-N-methyltaurate.

Suitable zwitterionic surfactants are derivatives of aliphatic quaternary ammonium, sulphonium and phosphonium compounds having an aliphatic radical of from 8 to 18 carbon atoms and an aliphatic radical substituted by an anionic water-solubilising group, for instance 3-(N—N-dimethyl-N-hexadecylammonium) propane-1-sulphonate betaine, 3-(dodecylmethyl sulphonium) propane-1-sulphonate betaine and 3-(cetylmethylphosphonium) ethane sulphonate betaine.

Further examples of suitable detergent-active compounds are compounds commonly used as surface-active agents given in the well-known textbooks “Surface Active Agents”, Volume I by Schwartz and Perry and “Surface Active Agents and Detergents”, Volume II by Schwartz, Perry and Berch.

### Electrolyte

Inclusion of small amount of an electrolyte (other than soap) can influence the liquid and solid phase ratio. Increasing the electrolyte content lowers the solubility of soap thereby increasing the solid phase amount, on the other hand lowering the electrolyte levels make the bars softer.

It is preferred that composition of the invention comprises 0.5 to 3 wt %, more preferably in the range of 0.5 to 2.5 wt % electrolyte, and most preferably 0.7 to 2.3% by weight of the composition. Preferred electrolytes include sodium sulfate, sodium chloride, sodium citrate, potassium chloride, potassium sulfate, sodium carbonate and other mono or di or tri salts of alkaline earth metals, more preferred electrolytes are sodium chloride, sodium sulfate, potassium chloride and especially preferred electrolytes are sodium chloride and sodium sulfate and combinations thereof. For the avoidance of doubt is clarified that the electrolyte is a non-soap material.

It is most preferred that sodium sulphate and sodium chloride are used as electrolytes for the composition of the present invention. The presence of sulphate, preferably sodium sulphate surprisingly gave improved hardness in the context of the present invention, i.e. used in the presence of silica gel.

It was observed that presence of sodium sulphate as an electrolyte gives better hardness to the bar. In fact, the presence of silica gel and sodium sulfate gives good hardness properties to the soap bar despite having high moisture as compared to soap bar having silica gel in the absence of sodium sulfate. It was further observed that if electrolyte levels were increased higher than 1 wt % in the absence of sodium sulfate, cracking of the soap bar was seen.

It is preferred that sodium sulphate is present in the range of 0.5 to 1.5 wt % of the weight of composition, more preferably 0.7 to 1.3 and most preferably 1 to 1.3 wt %. It is preferred that sodium sulphate is at least 0.5 wt %, more preferably at least 0.7 wt %, and most preferably at least 1 wt % and it is preferred that it is not more than 3 wt %, more preferably not more than 2.5 wt %, furthermore preferably not more than 2 wt % and most preferably not more than 1.5 wt % of the total weight of composition of the present invention.

It is preferred that when sodium chloride is present in the range of 0.5 to 1.5 wt % of the weight of composition, more preferably 0.7 to 1.3 and most preferably 1.0 to 1.3 wt %. It is preferred that sodium chloride is at least 0.5 wt %, more preferably at least 0.6 wt %, and most preferably at least 0.7 wt % and it is preferred that it is not more than 3 wt %, more preferably not more than 2.5 wt %, and further, more preferably not more than 2 wt % and most preferably not more than 1.5 wt % of the total weight of composition of the present invention.

### Opacifier

An opacifier may be optionally present in the composition. When opacifiers are present, the cleansing bar is generally opaque, i.e. “opacification”. Examples of opacifiers include titanium dioxide, zinc oxide and the like. A particularly preferred opacifier that can be employed when an opaque rather than a transparent soap composition is desired is ethylene glycol mono- or di-stearate, for example in the form of a 20% solution in sodium lauryl ether sulphate. An alternative opacifying agent is zinc stearate.

### Benefit Agents

Preferably the soap composition of the invention comprises one or more benefit agent not already disclosed earlier. Preferably the benefit agent is an emollient, sunscreen, anti-ageing compounds or moisturizers and humectants. The agents may be added at an appropriate step during the process. Some benefit agents may be introduced as macro domains.

Examples of moisturizers and humectants include cetyl alcohol, ethoxylated castor oil, paraffin oils, lanolin and its derivatives. Silicone compounds such as silicone surfactants like DC® 3225C (Dow Corning) and/or silicone emollients, silicone oil (DC-200® ex. Dow Corning) may also be included. Further examples include glycerin, oat kernel flour, Petrolatum, Aquaporin manipulation and hydroxyethyl urea.

Sunscreens such as 4-tertiary butyl-4′-methoxy dibenzoylmethane (available under the trade name PARSOL®1789 from Givaudan) or 2-ethyl hexyl methoxy cinnamate (available under the trade name PARSOL® MCX from Givaudan) or other UV-A and UV-B sun-screens may also be added. Further examples include Helioplex® (Diethylhexyl naphthylate), Ensulizole®, Ethylhexyl salicylate, Tinosorb® (S & M), Octocrylene® and Mexoryl®.

Lipids such as cholesterol, ceramides, and pseudoceramides, and exfoliant particles such as polyethylene beads, walnut shells, apricot seeds, flower petals and seeds may also be present. Structurants such as maltodextrin or starch may be used to structure the bars.

The composition can also optionally include other ingredients conventionally used in soap such as lather boosters, colourants and opacifiers and skin tone agents such as hexyl resorcinol, Soybean extract (Bowman Birk inhibitor), Octadecenedioic acid, (Arlatone® DC), niacinamide, Seppiwhite®, Acetylglucosamine, Pitera Extract, Symwhite® and Melano-block® (Calcium pantothenate). Further, the composition of the invention may comprise antiaging ingredient such as retinol, hyaluronic acid, Collagen, CoQ10 (ubiquinone), retinyl propionate, peptides, retinyl palmitate, Jasmonic acid derivatives and Proxylane®.

Other adjunct materials may include germicides and preservatives. These ingredients normally will be in amounts less than 2 wt %, usually less than 0.5 wt % and may include silver salts and silver compounds, thymol, terpineol and their analogues, ZPTO, chloroxylenol, PCMX, triclosan and trichlorocarbanilide.

The soap composition may include structurants. These may include water insoluble particulate material. Structurants may, individually or combined, support 0 to 25 wt %. Preferred inorganic particulate material includes talc and calcium carbonate. Talc is a magnesium silicate mineral material, with a sheet silicate structure represented by the chemical formula Mg₃Si₄(O)₁₀(OH)₂ and may be available in the hydrated form. Talc has a plate-like morphology and is substantially oleophilic/hydrophobic.

Examples of other optional insoluble inorganic particulate materials include zeolites aluminates, silicates, phosphates, insoluble sulfates, clays (e.g., kaolin, china clay), titanium oxide, zinc oxide and their combinations.

The compositions of the invention may additionally comprise anti-cracking agents such as acrylate polymers.

The term “slip modifier” is used herein to designate materials that when present at relatively low levels (generally less than 1.5% based on the total weight of the bar composition) will significantly reduce the perceived friction between the wet bar and the skin. The most suitable slip modifiers are useful, individually or combined, at a level of 1% or less, preferably from 0.05 to 1% and more preferably from 0.05 to 0.5%.

The composition of the present invention optionally comprises modified poly ethylene glycol in the range of 0.01 to 0.08% as a slip modifier and/or for other sensory benefits. The composition of the present invention may also optionally comprise modified ethylene acrylate copolymer in the range of 0.1 to 0.05% as a benefit agent.

Suitable slip modifier include petrolatum, waxes, lanolins, poly-alkane, poly-alkene, polyalkyene oxides, high molecular weight polyethylene oxide resins, silicones, polyethylene glycols and mixtures thereof.

Free fatty acids (FFA) up to 3% such as coconut fatty acid, PKO fatty acid, lauric acid are commonly used in soap bars for overall quality and process improvement. Free fatty acid higher than 3% could lead to soft and sticky mass and could negatively impact one or more physical feature. In at least one form, level of FFA in compositions of the invention is 0.05 to 3%, preferably 0.1 to 2%, more preferably 0.1 to 1.5 wt %.

A variety of test method have been used to determine properties of the soap compositions.

The test methods are hardness testing protocol, using a 30° conical probe which penetrates to depth of 15 mm. Another test is the rate of wear (RoW) which relates to the amount of material which is lost by a soap bar product under controlled conditions.

These conditions for use, mimic approximately the way consumers use the product. A further test is done to check for the extent of as the physical damage which may result (or not) from the sequence of washdown and drying of the bar. Yet another test is to determine “mush” defined as the jelly, creamy material that forms when toilet soap bars absorb water. The Mush Immersion Test gives a numerical value of the amount of mush formed on a bar.

All the aforesaid test methods have been described in US20190016994 A1 (Unilever).

### Process of the Invention

In accordance with a second aspect is disclosed a process for preparing a soap composition of the first aspect, comprising the steps of:
i) saponifying a fatty saponifiable matter with an alkali to produce a saponified mass, while monitoring the extent of saponification;
wherein 0.1 to 3 wt % of an electrolyte comprising sodium sulphate is added during the saponification process;
ii) adding a bicarbonate salt in the range of 0.5 to 5 wt % of the total soap composition to the saponified mass obtained from step (i) and mixing;
iii) adding water to the mix of step (ii);
iv) adding of alkaline silicate salt heated to 40 to 80° C. in the range of 0.25 to 5 wt % of the total soap composition; and optionally;
v) extruding said saponified mass into shaped products including noodles and bars.

It is preferred that in the process of the present invention, the soap composition comprises 45 to 75 wt % total fatty matter and 15 to 30 wt % moisture.

It is preferred that in the process of the present invention, the sodium sulphate is in the range of 0.1 to 1.5 wt % of total weight of the composition.

It is preferred that in the process of the present invention, the bicarbonate salt is sodium bicarbonate.

It is preferred that in the process of the present invention, the alkaline silicate salt is sodium silicate.

It is preferred that in the process of the present invention, silica gel is generated in situ by reaction of alkaline silicate salt and bicarbonate salt.

In another embodiment, 0.2 wt. % to 10 wt. % silica gel may be prepared separately and added after the step (i) to and optionally the saponified mass may be extruded into shaped products including noodles and bars.

The soap bar composition according to the present invention may be produced on a commercial scale by any of the processes known to a person skilled in in the art.

Preferably the soap bar composition of the present invention is prepared using the extrusion route. Preferably using a Sigma mixer process (Post dosing route) or a crutcher/Mazzonni/spray drier process.

Neutralizing fatty acid or fats to form fatty acid soap:

The fatty acids used for neutralization may be of a single type or a mixture of different fatty acids. Preferably the fatty acids are a mixture of different fatty acids. The fats used are a combination of those which provide the preferred amounts of short chain fatty molecules and long chain fatty molecules. As used herein the term fats also includes oils as is generally known to the person skilled in the art. The neutralization step is achieved by using an alkaline neutralizing agent preferably selected from silicate, carbonate, hydroxide, alkaline aluminium-containing material such as aluminate, a phosphate or mixtures thereof to form fatty acid soap, preferably the alkaline neutralizing agent is a hydroxide or silicate. Still preferably the alkaline neutralizing agent used for neutralization is sodium hydroxide or potassium hydroxide.

The process of the invention comprises the first step of heating to 60 to 80° C., a fat blend comprising lauric fatty acid and saturated and unsaturated non-lauric fatty acids in a blend tank, where iodine value of the fat blend is from 44 to 58 g/Iodine per 100 g. The main parts of a typical mixer are a jacketed barrel, axial rotating shaft through the centre of the barrel (longitudinally), plough-shaped blades mounted on the axial shaft, and chopper. The ploughs and the high-speed chopper are the mixing elements. Since the gap between the plough surface and the barrel is about 3 to 8 mm, the material gets sheared significantly while mixing. A typical mixer has barrel volume of 60 litres, plough rpm of 200 and chopper rpm of 3000. The plough area to barrel volume is approximately 0.002 cm⁻¹.

About a third of the blend from the melting tank is then transferred into the blend tank maintained at 60 to 80° C.

The process may be alternatively be carried out in any mixer conventionally used in soap manufacture. Preferably a high shear kneading mixer is used. The preferred mixers include kneading members of sigma type, multi wiping overlap, single curve or double arm. The double arm kneading mixers can be of overlapping or tangential in design. Alternatively, the invention can be carried out in a helical screw agitator vessel or multi head dosing pump/high shear mixer and spray drier combinations as in conventional processing.

The next step involves adding at least one reactant from a first group of reactants consisting of a water soluble poly carboxylic acid, a water-soluble salt of such acid, calcium chloride, a borate or OHC(CH²)nCHO, where n=2 to 6, while maintaining the temperature at 60 to 80° C.

The third step involves adding an alkali, preferably under shearing action, to saponify the fat blend. The saponification is preferably carried out to the extent of 80 to 100%. Preferably an aqueous solution or dispersion of the alkali is used. More preferably the alkali is caustic soda. Alternatively, any other suitable alkali may be used in stoichiometric amount which can be calculated easily. Temperature of the reaction mass increases due to exothermic nature of the saponification reaction. Preferably a portion of the total alkali is introduced into the mixer in an aqueous form.

Process for preparing in-situ silica gel:

The next step involves acidulating an alkaline silicate salt with an acid to form in-situ silica gel. Preferably the silicate salt is an alkaline metal silicate, still preferably sodium silicate and the acid are selected from an inorganic acid (preferably sodium bicarbonate) or organic acid. Preferably the acid is selected from carbon dioxide, organic acid, bicarbonate salt or mixtures thereof. Preferably the bicarbonate salt is sodium bicarbonate. During the step of acidulating, desired concentrations, approximately stoichiometric proportions or slight excess of silicate salt is mixed with the acid. The silicate salt may be added at room temperature or a further step of heating to a temperature within the range of about 45° C. to 80° C. preferably around 60° C. may be performed separately prior to mixing.

Reactants are introduced simultaneously into the reaction vessel at or substantially at atmospheric pressure in a closed vessel condition and the reaction mass is subjected to agitation to uniformly mix. The reaction is allowed to proceed to completion which generally takes around 20 to 30 minutes. After this, the pH of the silica gel is adjusted to the desired levels by the addition of the acid or silicate. The pH of the final dough mass is preferably adjusted to within the range of 7.2 to 10.0 pH.

The preparation of the soap bar composition involves preferably acidulating an excess of alkaline metal silicate with an acid source selected from bicarbonate salt, carbon dioxide or organic acid to form a silica gel. Preferably bicarbonate salt is reacted with an alkaline metal silicate salt to form a silica gel. Preferably the bicarbonate salt is sodium bicarbonate and the alkaline metal silicate salt is sodium silicate.

In one embodiment of the present invention, the step for preparing the laundry soap bar composition involves the step of preparing silica gel in-situ followed by preparing the silicate structuring agent in-situ. In this, the step of acidulating an excess of silicate salt with an acid preferably bicarbonate salt to form in-situ silica gel is followed by the step of contacting the remaining silicate salt with a source of magnesium to form magnesium silicate or a source of calcium to form calcium silicate or a source of aluminium to form sodium aluminium silicate and water to provide a dough mass.

### Crutcher Process:

Step (i): This is one of the well-known process for preparing a laundry soap bar composition. In the crutcher process the step of neutralizing one or more fatty acid or fat with an alkaline neutralizing agent to obtain fatty acid soap is carried out by adding the fatty acid or fats with the preferred ratio ranges of fatty acid with shorter chain length of C₁₂ or below and fatty acids with longer chain length of C₁₄ or higher in the crutcher which is maintained at a temperature of 50° C. to 90° C. The oils used may be selected from distilled fatty acids or neutral oils. Next an alkaline neutralizing agent preferably sodium hydroxide or potassium hydroxide is added in an amount required for achieving complete saponification of the fatty acids or fat. Thereafter the temperature of crutcher is increased to a range from 75° C. to 120° C. Preferably during the neutralizing step a desired amount of sodium carbonate or sodium chloride solution is added to the neutralizing mixture to obtain the fatty acid soap. Sufficient amounts of free water is added at this stage that is required to provide a final bar composition with 15 wt. % to 45 wt. % water. During the step of neutralizing the fatty acid or soap or immediately thereafter preferably a chelating agent is also added. Non-limiting examples of the chelating agent includes the EHDP and EDTA.

step (ii): The next step involves adding silicate structuring agent or generating silicate structuring in-situ. Preferably the silicate structuring agent is generated in-situ. Preferably the silicate structuring agent is aluminium based. Preferably the aluminium compound (example aluminium sulphate) is added in solid form or in the form of a solution into the crutcher and mixed for 5 to 10 minutes to form a homogeneous mixture with the fatty acid soap. This is followed by the addition of the alkaline silicate salt preferably sodium silicate in an excess to the stochiometric proportions in either ambient temperature conditions or slightly heated before addition to the crutcher. After addition the contents in the crutcher are mixed for around 5 to 10 minutes to completely react the aluminium compound with the alkaline silicate salt to form the silicate structuring agent. As discussed above, preferably the aluminium compound is aluminium sulphate and the alkaline silicate salt is sodium silicate which react to form sodium aluminosilicate.

Step (iii): Next step involves acidulating silicate salt with an acid to form the silica gel in-situ. Firstly, an acid preferably sodium bicarbonate is added to the crutcher. The sodium bicarbonate is preferably in the solid form. Thereafter an alkaline silicate salt is added in stoichiometric proportion is added to the mixture to and the mass is mixed for 5 to 10 minutes to form a dough mass with the silica gel formed in-situ. The silica gel holds the excess amount of the water.

Preferably at this stage cationic polymer may added to the dough mass. The addition of desired cationic polymer at the end of the process avoids any complex formation with the anionic soap. Other optional ingredients that may be added to the laundry soap bar includes the electrolytes, dyes, acrylic polymer and colorants, glycerine, chelating agents, soluble fillers, inorganic fillers, alkaline materials (carbonates) are added to form a dough mass.

The dough mass at this stage preferably has a moisture content in the range from 15 to 45 wt. %.

Drying: The dough mass formed is preferably dried in the next step. In this drying step, the dough mass is dried to reduce the moisture content of the mix to 15 wt. % to 45 wt. %. The drying step on a commercial basis may be achieved by several different methods. One procedure employs a water-chilled roll in combination with a second feed roll to spread molten, neutralized soap into a thin, uniform layer. The cooled dough mass is then scraped from the roll to form chips and dried to a specific moisture level in a tunnel dryer. A modern technique for the drying is known as spray drying. This process directs molten dough mass to the top of a tower via spray nozzles. The dough mass sprayed to form dried soap mix hardens and then dries in the presence of a current of heated air. Vacuum may be applied to facilitate removal of water, preferably the vacuum of at least 50 mm Hg absolute pressure is provided. The dried soap mix is then extruded to form soap noodles having a water content of 15 wt. % to 45 wt. %. During the drying step generally 4 wt. % to 7 wt. % of the moisture is removed from the dough mass. Preferably the drier is a mazzoni vacuum spray drier which is maintained at a temperature of 85° C. to 90° C. and the vacuum is maintained at 700 mm Hg and the flow rate is around 3 to 8 tonnes per hour.

Plodding: Preferably after drying, in dough mass is subjected to a plodding step, the dried soap noodles are transferred to a plodder. In the plodding, the step involves converting the soap noodles into a shaped laundry soap bar composition. A conventional plodder is set up with the barrel temperature at about 90ºF. (32° C.) and the nose temperature at about 110° F. (43° C.). The plodder used is a dual stage twin screw plodder that allows for a vacuum of about 40 to 65 mm Hg between the two stages. Preferably the perfume may be added at this stage. The soap log extruded from the plodder is typically round or oblong in cross-section and is cut into individual plugs. These plugs are then preferably stamped on a conventional soap stamping apparatus to yield the finished shaped laundry soap bar composition. After stamping the finished soap bar is packaged in desired packaging material which may be selected from laminate, films, paper or combinations thereof.

In a preferred process, prior to plodding the dried soap noodles may be subjected to an amalgamating step carried out in a simple paddle-type mixer where the noodles are added to an amalgamator in which adjunct ingredients such as colorants, preservatives, perfume are added and mixed thoroughly to combine all the ingredients together. Further to this, the mix from the amalgamator may be preferably subjected to a milling step. In the three-roll soap mill the amalgamated mixture is passed through the rolls set at a temperature from 29° C. to 41° C. to obtain a homogenous mix, This, is an intimate mixing step where the soap mix is subjected to compression and an intense shearing action. After mixing in the mill the mix is transferred to the plodder.

### Sigma Mixer (Post Dosing) Process:

Another well known process for preparing the laundry soap bar composition is known as the post dosing process or a sigma mixer process. The sigma mixer process involves the preparation of the soap noodles using the crutcher or a ploughshear mixer.

The step of neutralizing the fatty acid or the fat with the alkaline neutralizing agent is carried out in the crutcher mixer or a ploughshare mixer where the fatty acids or oils/fats with the desired levels of the fatty acid molecules with shorter chain length of C₁₂ or below and fatty acid molecules with longer chain length of C₁₄ or higher are added along with the alkaline neutralizing agent, preferably sodium hydroxide. This step is continued i.e. sodium hydroxide is added until the fatty acid or fats/oils is completely neutralised.

Preferably during the neutralizing step, a desired amount of sodium carbonate or sodium chloride solution is added to the neutralizing mixture to obtain the fatty acid soap. Sufficient amounts of free water is added at this stage that is required to provide a final bar composition with 17 wt. % to 40 wt. % water. During the step of neutralizing the fatty acid or soap or immediately thereafter preferably a chelating agent is also added. Non-limiting examples of the chelating agent includes the EHDP and EDTA.

In the next step the neutralized fatty acid soap is dried as described above in the crutcher process preferably in a vacuum spray drier. The soap noodles are formed with a moisture content of 15 wt. % to 45 wt. %.

In the next step 30 wt. % to 55 wt. % of dried fatty acid soap and desired levels of water to obtain a final laundry bar composition with 15 wt. % to 45 wt. % are added into the sigma mixer and the mixer is operated for preferably 10 to 15 minutes to homogenize.

Preferably in the next step the silicate structuring agent and the silica gel is formed as is described above in reference to the crutcher process to form a dough mass. The dough mass is thereafter subjected to a plodding step as described above. The dough mass is subjected to a plodding step, in which the dough mass is transferred to a plodder which involves converting the dough mass into a shaped laundry soap bar composition.

According to a third aspect, the present invention discloses the use of a silica gel, silicate structuring agent and 15 wt. % to 45 wt. % water in a laundry soap bar composition having 30 wt. % to 55 wt. % fatty acid soap for providing good user properties, improved bar properties, lather characteristics and/or improved fragrance delivery.

The invention will now be illustrated by means of the following non-limiting examples.

### EXAMPLES

A soap bar composition (E 1) according to the present invention was prepared using the formulation as shown in Table 1. The fatty acids/fats according to the required blend was weighed and neutralized using sodium hydroxide. The electrolytes sodium sulphate and sodium chloride were added during saponification process. In sigma mixture, soap noodles and sodium lauryl sulfate were crushed for 3 to 5 min. Sodium bicarbonate was added as powder and mixed for 2 min. Entire amount of water was added and mixed for 1-2 min. Then sodium silicate (45% liquid) was heated to 70 deg C. and added slowly and mixed for 6-10 min to allow the gel formation to happen. All minor ingredients and free fatty acid were added and mixed. Color and fragrance were also added and mixed. The resultant dough was shaped into a soap bar. A similar soap bar was prepared without sodium sulphate (E2) and a high TFM (72 wt %) conventional Soap bar was prepared for control. The formulations of the three soap bars are presented in Table 1.

Measurement of the bar parameters:

### Bar Hardness

Bar hardness refers to the hardness of the bar after manufacture which gives an indication of the processability, strength and retention of structural integrity during handling, transport and use.

Bar hardness was determined by using a TA-XT Express Texture Analyser has a 30° conical probe which penetrates into a soap bar sample at a specified speed to a pre-determined depth. The resistance generated at the specified depth is recorded. The bar whose hardness is to be measured is placed onto the testing platform. Then the probe of the measuring instrument is placed close to surface of the bar composition without touching it. Next the instrument is started, and the force required to reach a pre-set target distance is measured and the observation is recorded (force in g, gi).

This number can be related to the yield stress, which has long been known to be an important determinant of processability and is also related to in-use performance. The hardness of the bar was measured of the freshly prepared bars and after 24 hours of storage.

The following method was used to measure the product hardness:

### Hardness Testing Protocol

### Principle

A 30° conical probe penetrates into a soap/syndet sample at a specified speed to a pre-determined depth. The resistance generated at the specific depth is recorded. There is no size or weight requirement of the tested sample except that the bar/billet be bigger than the penetration of the cone (15 mm) and have enough area. The recorded resistance number is also related to the yield stress and the stress can be calculated as noted below. The hardness (and/or calculated yield stress) can be measured by a variety of different penetrometer methods. In this invention, as noted above, we use probe which penetrates to depth of 15 mm.

### Apparatus and Equipment

TA-XT Express (Stable Micro Systems)
30° conical probe—Part #P/30c (Stable Micro Systems)

### Sampling Technique

This test can be applied to billets from a plodder, finished bars, or small pieces of soap/syndet (noodles, pellets, or bits). In the case of billets, pieces of a suitable size (9 cm) for the TA-XT can be cut out from a larger sample. In the case of pellets or bits which are too small to be mounted in the TA-XT, the compression fixture is used to form several noodles into a single pastille large enough to be tested.

### Procedure

### Setting up the TA-XT Express

These settings need to be inserted in the system only once. They are saved and loaded whenever the instrument is turned on again. This ensures settings are constant and that all experimental results are readily reproducible.
Set test method
Press MENU
Select TEST SETTINGS (Press 1)
Select TEST TPE (Press 1)
Choose option 1 (CYCLE TEST) and press OK
Press MENU
Select TEST SETTINGS (Press 1)
Select PARAMETERS (Press 2)
Select PRE TEST SPEED (Press 1)
Type 2 (mm s⁻¹) and press OK
Select TRIGGER FORCE (Press 2)
Type 5 (g) and Press OK
Select TEST SPEED (Press 3)
Type 1 (mm s⁻¹) and press OK
Select RETURN SPEED (Press 4)
Type 10 (mm s⁻¹) and press OK
Select DISTANCE (Press 5)
Type 15 (mm) for soap billets or 3 (mm) for soap pastilles and press OK
Select TIME (Press 6)
Type 1 (CYCLE)

### Calibration

Screw the probe onto the probe carrier.
Press MENU
Select OPTIONS (Press 3)
Select CALIBRATE FORCE (Press 1)—the instrument asks for the user to check whether the calibration platform is clear
Press OK to continue and wait until the instrument is ready.
Place the 2 kg calibration weight onto the calibration platform and press OK
Wait until the message “calibration completed” is displayed and remove the weight from the platform.

### Sample Measurements

Place the billet onto the test platform.
Place the probe close to the surface of the billet (without touching it) by pressing the UP or DOWN arrows.
Press RUN
Take the readings (g or kg) at the target distance (Fin).
After the run is performed, the probe returns to its original position.
Remove the sample from the platform and record its temperature.

### Calculation & Expression of Results

### Output

The output from this test is the readout of the TA-XT as “force” (R_{T}) in g or kg at the target penetration distance, combined with the sample temperature measurement. (In the subject invention, the force is measured in Kg at 40° C. at 15 mm distance)

The force reading can be converted to extensional stress, according to the equation given below.

The equation to convert the TX-XT readout to extensional stress is

$$σ = \frac{1}{C} \frac{{R}_{T} {g}_{c}}{A}$$

where: σ=extensional stress
C=“constraint factor” (1.5 for 30° cone)
G_{c}=acceleration of gravity
A=projected area of cone=π(d tan 1/2θ)²
d=penetration depth
θ=cone angle

For a 30° cone at 15 mm penetration, Equation 2 becomes

$$σ ( P a ) = {R}_{T} ( g ) \times 128. 8$$

This stress is equivalent to the static yield stress as measured by penetrometer.

The extension rate is:

$$\dot{ε} = \frac{V}{d tan ( \frac{1}{2} θ )}$$

where \acute{ε}=extension rate (s⁻¹)
V=cone velocity
For a 30° cone moving at 1 mm/s, \acute{ε}=0.249 s⁻¹

### Temperature Correction

The hardness (yield stress) of skin cleansing bar formulations is temperature-sensitive. For meaningful comparisons, the reading at the target distance (R_{T}) should be corrected to a standard reference temperature (normally 40° C.), according to the following equation:

$${R}_{40} = {R}_{T} \times exp [ α ( T - 40 ) ]$$

where R₄₀=reading at the reference temperature (40° C.)
R_{T}=reading at the temperature T
α=coefficient for temperature correction
T=temperature at which the sample was analyzed.

The correction can be applied to the extensional stress.

### Raw and Processed Data

The final result is the temperature-corrected force or stress, but it is advisable to record the instrument reading and the sample temperature also.

A hardness value of at least 1.2 kg (measured at 40° C.), preferably at least 2.7 kg is acceptable.

### Efflorescence Measurement

Usually, efflorescence is hair like, or powdery material formed on soap bar surface. Soap bars were stored in different storage condition (25, 37, 45 & 50 deg. C) up to 12 weeks to check efflorescence. Soap bars are pulled out from storage at different time interval and checked visually for efflorescence.

TABLE 1

| | | | | Com- |
|---|---|---|---|---|
| | Com- | | | parative |
| Ingredients | parative | E1 | E2 | E3 |
| TFM 20 PKO, | 71 | 63 | 58 | 59 |
| 40 IV | | | | |
| Sodium chloride | 0.7 | 0.7 | 0.7 | 0.7 |
| Glycerin wt. % | 2.0 | 2.0 | 3.5 | 3.5 |
| Sodium sulphate | — | — | 1.2 | 1.2 |
| Sodium | — | 1.0 | 1.0 | 0 |
| bicarbonate | | | | |
| Sodium silicate | — | 2.25 | 2.25 | 2.25 |
| Sodium Lauryl | 0.00 | 0.00 | 1.00 | 1.00 |
| sulfate | | | | |
| Alpha olefin | 0.00 | 0.00 | 1.00 | 1.00 |
| sulfonate | | | | |
| Water | 16.0 | 25 | 25 | 25 |

Other Minor ingredients made up to 100

TABLE 2
Efflorescence

| Sample Name | Observation |
|---|---|
| Comparative | Observed |
| E1 | Not Observed |
| E2 | Not Observed |
| E3 | Observed |

Hardness:

| Sample | Hardness Kg-F |
|---|---|
| Name | @ 40 deg. C. |
| Comparative | 4.0 |
| E1 | 2.76 |
| E2 | 3.2 |

The data suggests that similar bar prepared as in E1 with in situ generation of silica gel shows better hardness and is able to better incorporate water than the conventional soap. It is also further observed by comparing E1 and E2 that presence of sodium sulphate as an electrolyte gives better hardness to the bar. It was further observed that if electrolyte levels were increased higher than 1 wt % in the absence of sodium sulfate, cracking of the soap bar was seen.

Minimum hardness required for bar processing is ˜3 Kg-F measured at 40 deg. C. Soap Bars with silicate & Bicarbonate (silica gel) with moisture 25%, (E1) is softer & Bar hardness is 2.76 Kg-F. However, incorporation of sodium sulphate improves bar hardness to 3.2 Kg-F at 40 deg. C. (E2). Also 2% surfactants (1% Sodium lauryl sulphate & 1% Alpha olefin sulfonate) were included in E2 to improve the lather performance of the soap bar. Generally, these surfactants are known to make soap bar softer. In spite of this, E2 soap bar is harder than E1 soap bar.

It is further seen that in the control sample efflorescence is seen and when silica gel is not formed, sodium silicate is present in E3, efflorescence is seen. Therefore, it was a surprising finding of the present invention that silica gel prevents efflorescence and provides good hardness despite the presence of sodium silicate.

1. A soap composition comprising:
i. 45 to 75 wt % total fatty matter;
ii. 0.1 to 3 wt % electrolyte comprising sodium sulphate;
iii. silica gel; and
iv. 15 to 30 wt % moisture,
wherein the soap composition comprises less than 1% by weight of an acrylic/acrylate polymer.

2. The soap composition as claimed in claim 1, wherein free alkali content of said soap is 0.05 to 0.1 wt %.

3. The soap composition as claimed in claim 1, wherein the sodium sulphate is in the range of 0.1 to 1.5 wt % of total weight of the composition.

4. The soap composition as claimed in claim 1, wherein the electrolyte further comprises sodium chloride.

5. The soap composition as claimed in claim 4, wherein the sodium chloride is in the range of 0.5 to 1.5 wt % of total weight of the composition.

6. The soap composition as claimed in claim 1, wherein the fatty matter in saponified form has an iodine value in the range of 30 to 45 g/Iodine per 100 g of the said saponified fatty matter.

7. The soap composition according to claim 1, wherein the composition comprises from 0.2 wt. % to 10 wt. % of the silica gel.

8. The composition according to claim 1, wherein the composition has a pH when measured in a 4% solution with distilled water at 25° C. in the range from 9 to 13.

9. A process for preparing a soap composition according to claim 1, comprising the steps of:
i) saponifying a fatty saponifiable matter with an alkali to produce a saponified mass, while monitoring the extent of saponification.
wherein 0.1 to 3 wt % of an electrolyte comprising sodium sulphate is added during saponification;
ii) adding a bicarbonate salt in a range of 0.5 to 5 wt % of total weight of the soap composition to the saponified mass obtained from step (i) and mixing to produce a mix;
iii) adding water to the mix of step (ii);
iv) adding an alkaline silicate salt heated to 40 to 80° C. in the range of 0.25 to 5 wt % of total weight of the soap composition; and optionally.
v) extruding said saponified mass into shaped products, the products being soap noodles or bars.

10. The process according to claim 9, wherein the soap composition comprises 45 to 75 wt % total fatty matter and 15 to 30 wt % moisture.

11. The process according to claim from 9, wherein, silica gel is generated in situ by reaction of the alkaline silicate salt and bicarbonate salt.

12. The process according to claim 9, wherein the bicarbonate salt is sodium bicarbonate.

13. The process according to claim 9, wherein the alkaline silicate salt is sodium silicate.

14. The process according to claims from 9, wherein the sodium sulphate is added in the range of 0.1 to 1.5 wt % of total weight of the composition.

15. The soap composition according to claim 1, wherein the soap composition has moisture in the range of 15 to 30 wt % and a hardness of at least 3 Kg-F measured at 40° C.

16. The composition according to claim 8, wherein the composition comprises less than 2.0×10⁻⁶ wt % acrylic/acrylate polymer by weight of the composition.

17. The composition according to claim 1, wherein the composition further comprises niacinamide, acetylglucosamine, Pitera extract, calcium panthothenate, retinol, hyaluronic acid, collagen, ubiquinone, retinyl propionate, a peptide, retinyl palmitate, germicide preservative, silver compounds, thymol, terpineol, zinc pyrithione, zeolite, an aluminate, silicate, phosphate, insoluble sulfate, clay, titanium oxide, zinc oxide, chloroxylenol, triclosan, trichlorocarbanilide or a mixture thereof.
